(19) United States
(12) Patent Application Publication
(10) Pub. No.: US 2026/0204074 A1
(43) Pub. Date: Jul. 16, 2026

(54) METHOD FOR DETECTING LEFT OBJECT AND INTEGRATED SYSTEM BY USING THE SAME

(71) Applicant: Ming Chi University of Technology, Taipei City (TW)

(72) Inventors: Wen-Chin Tsai, Taipei City (TW); Yen-Chen Chen, Taipei City (TW)

(21) Appl. No.: 19/443,010

(22) Filed: Jan. 7, 2026

(30) Foreign Application Priority Data
Jan. 13, 2025 (TW) 114101280

(51) Int. Cl. G06V 20/52; G06T 3/40; G06T 7/246; G06V 10/26; G06V 10/30; G06V 10/75; G06V 10/94; G06V 20/40

(52) U.S. Cl. CPC G06V 20/52; G06T 3/40; G06T 7/251; G06V 10/273; G06V 10/30; G06V 10/751; G06V 10/95; G06V 20/41; G06T 2207/10016; G06T 2207/10024; G06T 2207/30232

(57) ABSTRACT

A method for detecting a left object contains steps of: a step A of executing a pre-processing procedures, a step B of matching and tracking, and a step C of detecting the left object. In the step A includes: 1) taking a pixel and initializing a background model; 2) taking a new pixel and comparing the new pixel with the background model; 3) updating the values of the background model as the values of the new pixel value with a predetermined probability; 4) repeating the steps of 2) and 3) until all pixels are processed completely; and 5) detecting the left object in a scene. In the step B, the left object is detected in an original RGB image, and the object that often appearing in a monitoring environment is selected. In the step C, the object is detected to determine whether being seen commonly in the scene.

### TECHNICAL FIELD

The present invention relates to a method for detecting a left object and an integrated system by using the same which are capable of monitoring the left object in a public space.

### BACKGROUND

Past studies have used detection methods to define eight categories of left objects such as furniture, mattresses, sofas, etc. However, in real-world, defining the left objects in eight categories is not comprehensive because of a diversity of the left objects. Therefore, the method for detecting features of the left objects can only be applicable for specific occasions. Another study pointed out that the color of the left objects may be similar to that of the background or not obvious, thus resulting in a low signal-to-noise ratio or detection errors. For example, if the left object is a dark object, it will appear dark after being photographed, close to the asphalt road surface, thus increasing the difficulty of identification. The above-mentioned studies pointed out that the left objects are difficult to detect, since their appearance color is similar to the background color.

Furthermore, the environment for detecting objects is affected by the weather and reflections. In terms of weather, if it rains during monitoring, the noise generated by the rain on the image will increase the complexity of identification. Another scene is to consider an environment with water, glass or mirrors. For example, in a rainy scene, the rider who throws the object was wearing a raincoat. After the rain, there is water in the monitoring site. The images generated by water stains on the ground, the water surface in the scene, glass, and reflective mirrors are not garbage, but they will interfere with identification and increase the difficulty of identification

The present invention has arisen to mitigate and/or obviate the afore-described disadvantages.

### SUMMARY

The primary aspect of the present invention is to provide a method for detecting a left object and an integrated system by using the same which are applied to detect the behavior of placing the object in a public space, and are expanded to industrial production and manufacturing sites to monitor whether the object is left at fixed inspection points, such as a tools, a bucket, personal belonging, and people (who accidentally fall to the ground in the scene). For example, it is used to detect illegal dumping or discarding of garbage by residents in neighborhood alleys. In detection scenes, detecting the left object is realized outdoors because the outdoor scenes are more variable in terms of light and shadow than the indoor scenes. The left object also has various characteristics because of different scenes. Therefore, after implementing this system, it is expanded to monitored production and manufacturing sites and indoor public space in the future.

To obtain above-mentioned aspects, a method for detecting a left object provided by the present invention contains steps of: a step A of executing a pre-processing procedures, a step B of matching and tracking, and a step C of detecting the left object.

In the step A includes:
1) taking a pixel and initializing a background model which has values taken in a past at a same location or a neighborhood;
2) taking a new pixel and comparing the new pixel with the values of the background model, wherein when values of the new pixel are close to values of the background model, the new pixel is determined to the background, otherwise the new pixel is considered to the foreground;
3) when the new pixel is determined to the background, the values of the background model is updated as the values of the new pixel with a predetermined probability, and the values of the new pixel are propagated to the background model of the neighboring pixels with a predetermined probability; and
4) repeating the steps of 2) and 3) until all pixels are processed completely; and
5) detecting the left object in a scene;

In the step B, the left object is detected in an original RGB image, and the object that often appearing in a monitoring environment is selected.

In the step C, the object is detected to determine whether being seen commonly in the scene based on an object overlap ratio, an object displacement, and an object staying time.

Preferably, in the step C, detection conditions includes:
1) when the object is not continue to move, a movement threshold (thr_{moved}) is defined, wherein when the object is less than the movement threshold, the object is the left object;
2) when the object continues to stay in a same place, defining a threshold for a duration of an object's staying (thr_{stay-up-duration}), wherein when the object stays in the scene for a period of time and a staying time is greater than the threshold, the object is considered as the left object;
3) when the object is not recognized in a scene, defining an object detection function f(x)_{object-detection}, with an input being the object to be tracked, and the output being true or false, indicating whether a common object is detected;
wherein when any of the 1) to 3) does not meet a standard of the left object, checking whether the staying time duration_{stay_up} is greater than thr_{stay-up-duration}/2; if so, a displacement amount is reset to indicate that the object is still moving, thus solving a situation where the left object is continuously moving, such as discarding the left object from a car, or a situation where the left object is thrown a distance far away.

Accordingly, the method for detecting the left object and the integrated system by using the same have advantages as follows:
1) proposing an improved foreground detection algorithm architecture to capture dynamic behaviors in video and match them with the object detection, and to enhance the foreground by reducing resolution and noise and expanding the foreground to solve the problem of object detection errors in situations where the environment changes;
2) using the algorithms to match and track the left object, solving the misjudgment of the left object because of light and shadow reflections, and tracing back to find the person who loses the object; and
3) training model by using an artificial intelligence to predict and extract tracking image features, and the cosine similarity comparison method is configured to detect the left object, thus solving difficulty in identifying the left object.

### BRIEF DESCRIPTION OF THE DRAWINGS

FIG. 1 is a schematic view showing the assembly of an integrated system for detecting a left object according to a preferred embodiment of the present invention.

FIG. 2 is a flow chart of a method for detecting the left object according to the preferred embodiment of the present invention.

FIG. 3 is a flow chart of a step of pre-processing procedure of the method according to the preferred embodiment of the present invention.

FIG. 4 is a flow chart of a step of matching and tracking of the method according to the preferred embodiment of the present invention.

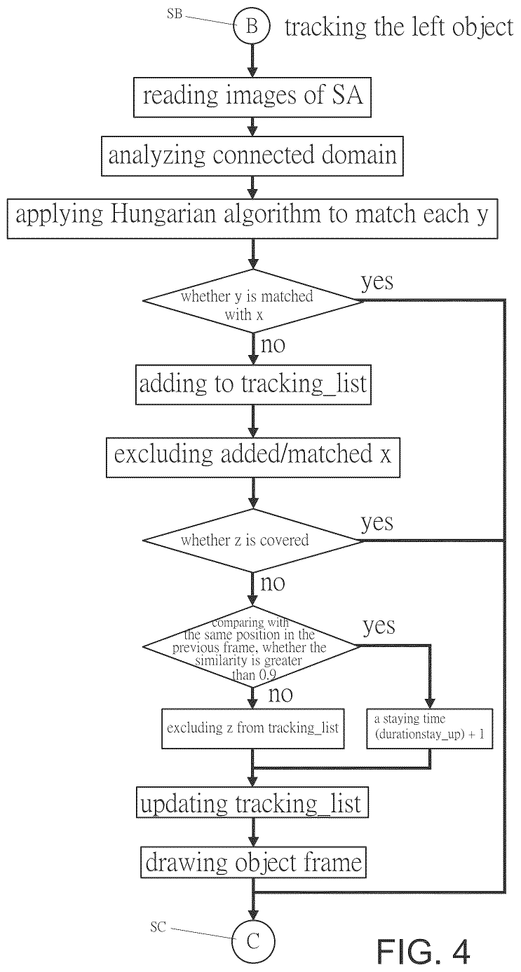

FIG. 5 is a flow chart of a step of detecting the left object of the method according to the preferred embodiment of the present invention.

FIG. 6 is a flow chart of operating the integrated system according to the preferred embodiment of the present invention.

### DETAILED DESCRIPTION

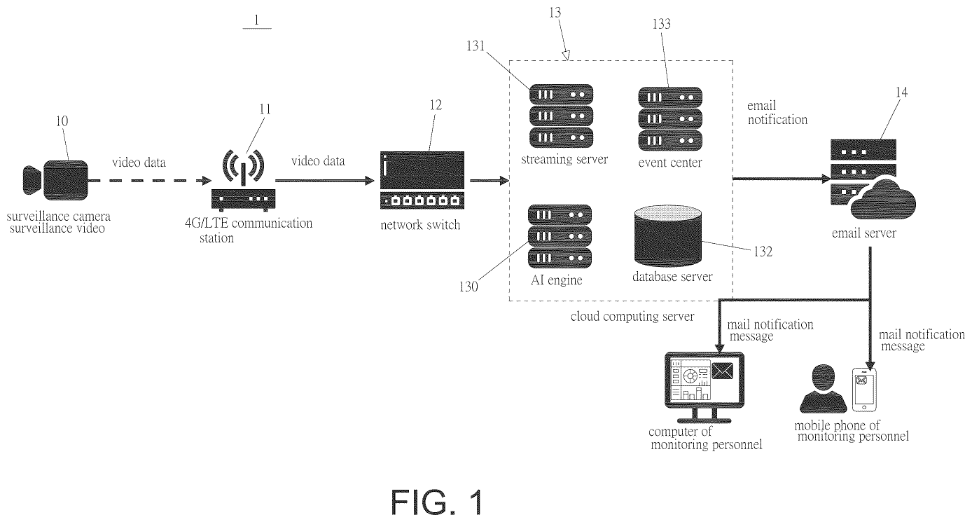

With reference to FIG. 1, an integrated system 1 for detecting a left object according to a preferred embodiment of the present invention is connected with a network and comprises: a surveillance camera 10, a communication station 11, a network switch 12, a cloud computing server 13, and a mail server 14, wherein the cloud computing server 13 includes at least one artificial intelligence engine (AI Engine) 130, a streaming server 131, a database server 132, and an event center 133; the surveillance camera 10 is configured to capture a real-time surveillance video at a fixed point and to transmit a video data of the real-time surveillance video via a communication network. The real-time surveillance video is transmitted to the cloud computing server 13 via the communication station 11 and the network switch 12, and a streaming image is received by the streaming server 131. The AI engine 130 is configured to execute a method for detecting the left object and is provided in the integrated system 1. When the left object is detected, a detected data of the left object is immediately transmitted to the event center 133 to start an event processing, save the detected data of the left object in the database server 132, and to notify monitoring personnel from the email server 14 notifies via a computer or a mobile phone of the monitoring personnel. The AI engine 130 is also planned to read files and execute an offline analysis, thus executing monitoring in a detected field.

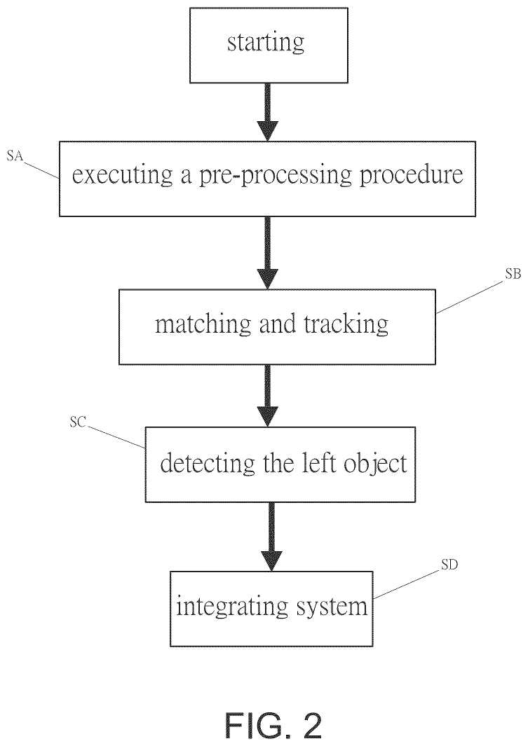

Referring to FIG. 2, the method for detecting the left object by using the integrated system of the present invention comprises: a step A of executing a pre-processing procedure (SA), a step B of matching and tracking (SB), and a step C of detecting the left object (SC). The SA is configured to execute a foreground detection and enhancement, the SB is configured to analyze the object in previous and next frames by using an algorithms, and the SC is configured to detect the left object in the detected field based on an object overlap ratio, an object size difference, an object similarity, an object displacement amount, an object staying time, and whether the left object is an uncommon object in the detected field. After the left object is detected, the detected data is transmitted to the event center 133 to start the event processing, save the detected data of the left object in the database server 132, and to notify the monitoring personnel from the email server 14 via the computer or the mobile phone of the monitoring personnel, thus completing a system integration (SD).

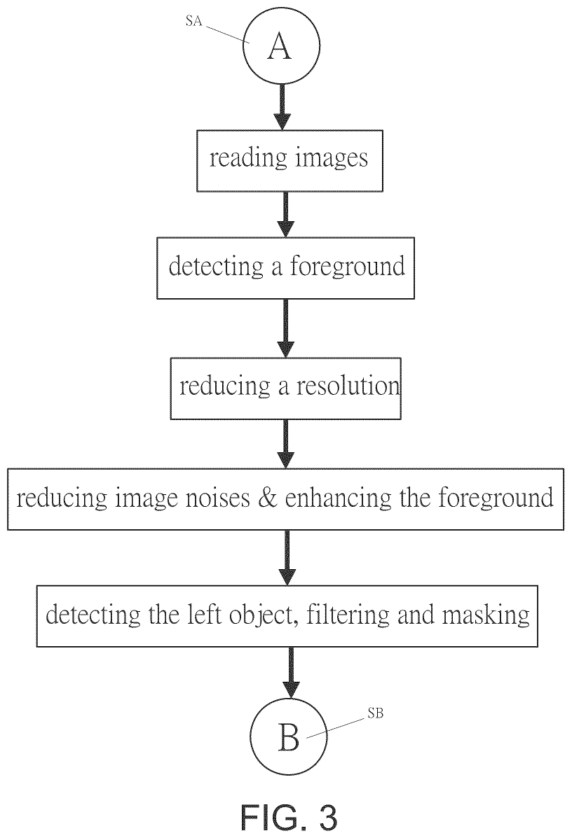

As shown in FIG. 3, the step A of executing the pre-processing procedures (SA) further includes reading images, detecting a foreground, reducing a resolution and image noises, enhancing the foreground, detecting the left object, filtering and masking.

The reading images are executed by using an offline analysis and an online real-time analysis to read offline files and online real-time images, wherein the online real-time images come from the surveillance camera 10, and the foreground and the left object are detected after reading the offline files and the online real-time images.

In the step of detecting the foreground includes:
1) taking a pixel and initializing a background model which has values taken in a past at a same location or a neighborhood;
2) taking a new pixel and comparing the new pixel with the values of the background model, wherein when values of the new pixel are close to values of the background model, the new pixel is determined to the background, otherwise the new pixel is considered to the foreground;
3) when the new pixel is determined to the background, the values of the background model is updated as the values of the new pixel with a predetermined probability, and the values of the new pixel are propagated to the background model of the neighboring pixels with a predetermined probability; and
4) repeating the steps of 2) and 3) until all pixels are processed completely.

In addition, considering the images input from the surveillance camera or the offline files, when no background has been established in a step of initializing the system, a first image is the background after reducing a resolution and image noises of the first image. After a second image is input, the algorithm is executed on the second image and the first image. Through a result of subtraction of the above-mentioned images, changes in the images are obtained, thus completing the foreground detection. The rest of the smaller differences are the background. When a change occurs, it means that it may be a potential foreground, thus finishing the foreground detection.

After the foreground detection is completed, a mask is generated. A content marked by the mask is the foreground and background after subtracting the two images. The foreground is marked in white, and the background is marked in black, wherein BGS_Frame represents a result of a frame after executing a background subtraction (BGS).

After the foreground detection, there are quite a lot of tiny white dots in BGS Frame, which need to be filtered out through processing, wherein reducing the resolution in the pre-processing procedures is configured to remove the tiny white dots and to reduce a subsequent calculation amount.

Reducing image noises in the pre-processing procedure is configured to reduce an impact of an external environment on the images, but an operating method is different from reducing the resolution. The method of reducing image noises of the present invention is to calculate a number of white pixels in a connected area of BGS Frame and to set a threshold value thr_{denoise} for a noise reducing judgment. When the number of the white pixels in the connected area WPixel_{BGS-CC} is less than thr_{denoise}, it is regarded as noise. All white areas regarded as the noise (the foreground with a value 1) are changed to a black (the background with a value 0), thus filtering the noises. The filtering process is shown in the following formula 1.

$$If {WPixel}_{BGS - CC} < {thr}_{denoise} , set {WPixel}_{BGS - CC} = 0 \qquad ( formula 1 )$$

After reducing the noises, dilation is executed twice to strengthen a foreground range and become a foreground mask BGS_Mask. When detecting the left object later, the foreground and the background are distinguished more accurately.

Detecting the left object, filtering and masking are a method for capturing people and vehicles that initiate residual actions in the integrated system. Specific detection procedures inclusive of detecting the left object, filtering and masking are described as follows:

Left object detection>this object detection is to detect the left object in an original RGB image. The left object detection of the present invention is to quote an official YOLO model and select object that often appear in the monitoring environment, such as: people, cars, bicycles, motorcycles, dogs, cats, etc. for detection

Filtering>After detecting, a series of left object in the image is obtained. In the meantime, the detected left object of a target need to be enhanced. An enhancement method is to first initialize a completely black image without any mask represented as a total mask. For each detected left object, YOLO is used to mark the left object's bounding box (BBox). An area framed by the Bounding Box (BBox) is the foreground (FG) plus the background (BG). A sum of FG and BG represents a size of the BBox, which is WPixel_{YOLO}. Then, a ViBe algorithm is used to execute a foreground-background segmentation (BGS). After calculating, a mask obj_mask of the foreground left object is generated. The area size of the mask obj_mask is calculated to get WPixelBGS. After obtaining the foreground WPixel_{BGS} and a size of the BBox WPixel_{YOLO}, a ratio of the foreground WPixel_{BGS} in the WPixel_{YOLO} of BBox is calculated and is expressed as Ratio_{WPixelBGS}. A calculating process is as shown in Formula 2. When the ratio is too low, it is not a monitored left object and must be filtered out, wherein a filtering threshold is expressed as Thr_{WPixelRatio}. When Ratio_{WPixelBGS} is less than Thr_{WPixelRatio}, it must be filtered out. A filtering method is to set an entire area of the left object to 0, as shown in following Formula 3.

$$\frac{FG}{FG + BG} = \frac{{WPixel}_{BGS}}{{WPixel}_{YOLO}} = {Ratio}_{WPixelBGS} \qquad ( Formula 2 )$$

$$If {Ratio}_{WPixelBGS} < {Thr}_{WPixelRatio} , set {WPixel}_{BGS} = 0 \qquad ( Formula 3 )$$

A mask processing>the mask processing part is divided into three steps: retaining the detected left object, retaining the foreground left object, and reducing noises. After filtering, all left object obj mask that are continuously detected, wherein they are executed and calculated with total mask to maintain all left object that need to be detected, as shown below

$$for each obj\_Mask : total\_mask = total\_mask ∨ obj\_mask$$

After processing the detected left object, the foreground detection result is processed again, and a total mask and BGS mask are executed or calculated, as shown below:

$$total\_mask = total\_mask ∨ BGS\_mask$$

After processing, the noise reducing process is finally performed. The purpose of reducing the image noises is to eliminate some small points so as to remove noises. The purpose of reducing the image noises here is to enhance the foreground. The specific processing methods include blurring, binarization, dilation, and filtering. The purpose of the first three steps, blurring, binarization, and dilation, is to reduce noises or details, remove unnecessary details or object, and enhance the edges or features in the images to make them more prominent.

Finally, in the filtering, since all the left object left at this step are tracked later, a threshold value thr_{drop} for filtering object is set. When the number of pixels WPixel_{obj_mask} covered by any object mask is less than thr_{drop}, the area of the object is set to 0 and is removed from total mask, as shown in Formula 4.

$$If {WPixel}_{obj \_ mask} < {thr}_{drop} , set {WPixel}_{obj \_ mask} = 0 \qquad ( Formula 4 )$$

If the system does not detect any left object when detecting the left object, total_mask performs noise reducing with foreground BGS_mask, as shown below

$$total\_mask = denoise ( ( BGS\_mask )$$

After detecting the left object and processings, the BBox and total_mask of the object list are output for subsequent tracking calculations of the object.

The object matching and tracking process (SB) is to continuously update the object that need to be tracked, and the process is as follows: Error! Reference source cannot be found. 4. The list of object being tracked is represented by a tracking_list, wherein the tracking_list is a list used to save the object currently being tracked. In each frame, the tracking_list is updated. When an object is considered new or does not match with a currently tracked object, the object is added to the tracking_list. When an object has not been matched for multiple consecutive frames, it is removed from the tracking_list.

The following defines the variables used in the tracking process, such as x, y, Z
x: an object in the tracking list (tracking_list), used to match with object y in interest box;
y: an object in interest_box (the object box list of the current frame);
z: an object in the tracking list (tracking_list) used to check if it is covered by other object or if it has not been matched to the foreground for several consecutive frames;

After the program is executed, it continues the pre-processing program and outputs BBox and total_mask to analyze the object in the connected domain and generate an interest_box of object of interest, wherein the interest_box is a list used to store all object in the current frame.

The interest_box is obtained by connected domain analysis. Each object is a rectangular box, indicating the position of the object in the image. The implementation method of connected domain applies the connectedComponentsWithStats( ) function in OpenCV to analyze and obtain information such as the object's bounding rectangle and area.

After the connected domain analysis is completed, the algorithm is executed for each y to see whether there is a corresponding x that is matched. In an object matching, the interest_box is the input object list and the tracking_list is the tracking_list of the object to be tracked. When the system is initialized to match the interest_box with the tracking_list, there is no object to be tracked, and all objects in the interest_box are added to the tracking_list. After the second image is input, matching the interest_box with the tracking_list is started. Multiple variables used in the present invention for matching include an intersection area (IoU), a size difference (size-diff) and a similarity (similarity). The intersection area (IoU) is denoted as a size of an intersection area of two matched objects, wherein a variable of IoU is between 0 and 1, 0 represents no intersection between the two objects, and 1 represents an overlap between the two matched objects. The closer the IoU value is to 1, the more the two matched objects match. The size-diff is denoted as a difference in an area of the BBox of the two matched objects being matched, and the area is the number of pixels. A calculation method of size-diff is to subtract the number of pixels of the two matched objects and divide an absolute value by a larger value between the two matched objects. A value of the size-diff obtained after calculation is between 0 and 1, wherein the closer the value is to 0, the more matched the two matched objects are. This calculation method is as shown in Formula 5.

$$size - diff = \frac{\vert {Wpixel}_{inter - box} - {WPixel}_{tracking - box} \vert}{max ( {Wpixel}_{inter - box} , {Wpixel}_{tracking - box} )} \qquad ( Formula 5 )$$

As for the similarity, the present invention refers to a concept of person re-identification, it means, the Torchreid library provided in OpenCV, which has the ability to train the model by using a deep learning so that the trained model has the ability to extract features from the image.

After extracting features, feature vectors are generated from the object in the interest_box and the objects in the tracking_list, wherein two feature vectors are operated by cosine similarity to obtain a degree of similarity between the two feature vectors, wherein similarity is a value between −1 and 1, 1 represents the most similar, and −1 is denoted as the least similar, thus obtaining matching.

When the matching is successful, it continues to determine whether it is a left object. If the matching fails, it means this is a new object. It is added to the tracking_list for continuous tracking in the next frame. After excluding the matched object, checking whether the object is blocked. When the object frame overlaps with a range of other object frames in the current frame, it means that the object is blocked and it is necessary to confirm whether it is the left object. When it is not covered, checking whether the similarity is greater than 0.9. When it is greater than 0.9, it means that the object is currently being tracked and has a staying time (duration stay up)+1. When the similarity is less than 0.9, it means that the object in the image has changed and the similarity is not high. When an object fails to match with the foreground for several consecutive frames, it means that the object is the background and is removed.

After the matching process, the object in the interest_box and tracking_list has to be updated. The object in the interest_box replaces the corresponding object in tracking_list based on a matching relationship. Finally, the object box is marked and output to the left object detection program.

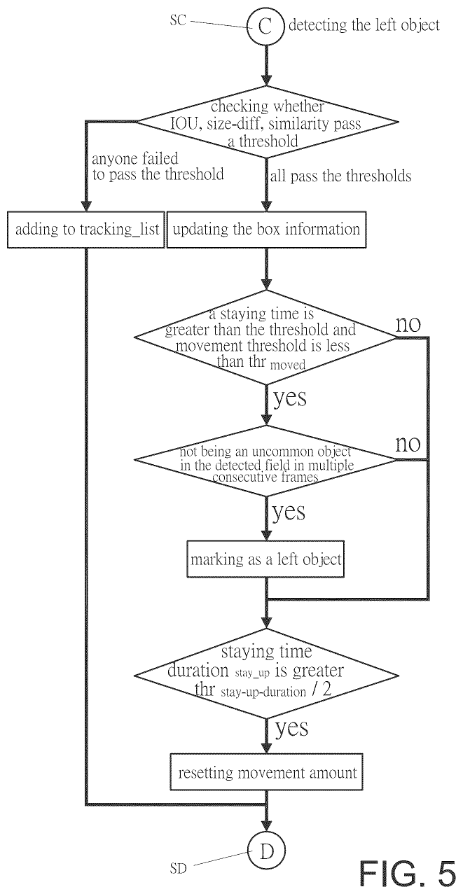

A flow chart of a left object detection process is shown in FIG. 5. The data input to the left object detection program is the list of object in the interest_box that have been matched. In this detection program, each matched object is first compared with the interest_box and the tracking_list to check whether the intersection area (IoU), the size difference (size-diff), and the similarity (similarity) are consistent with the same object, thus overcoming misdetection of highly homogeneous object. For example, when garbage is packed in bags of the same color and more than one bag is thrown away at the same time, misjudgment occurs when it is discarded. After detecting, when any of the three conditions, namely, the intersection area (IoU), the size difference (size-diff), and the similarity does not meet the set threshold conditions, it means that the object is not the target object and is separated from the original image into a new object and is added to the tracking_list to continuous track when the next image is input. This procedure is very important. When a person leaves the object, the two objects in the image begin to separate. This is because the object continuously tracked and not matched is added with the separated object. On the contrary, when all three thresholds are passed, it means that the object is currently being continuously tracked. After updating the box information of the object frame, further detecting is required to determine whether it is the left object.

To detect whether the current object is a left object, it must first clearly define what a left object is. According to a nature of the left object, the present invention sets the detection conditions as follows: 1) when the object does not continue to move, a movement threshold (thr_{moved}) is defined, wherein when the object is less than the movement threshold, it is the left object, as shown in Formula 6; 2) when the object continues to stay in a same place, defining a threshold for a duration of an object's staying (thr_{stay-up-duration}), wherein when the object stays in a scene for a period of time and a staying time is greater than the threshold, it is considered as the left object, as shown in Formula 7. When the object is not recognized in the scene (such as people, cats, dogs, vehicles, etc.), defining an object detection function f(x)_{object-detection}, with an input being the object to be tracked, and the output being true or false, indicating whether a common object is detected, as shown in Formula 8. Thereby, it prevents people, cats, and dogs from staying at the scene of the left object for a period of time and being mistakenly identified as the left object.

$$If {motion}_{obj} < {thr}_{moved} , set {Flag}_{trash - c 1} = true \qquad ( Formula 6 )$$

$$If {duration}_{stay \_ up} > {thr}_{stay - up - duration} , set {Flag}_{trash - c 2} = true \qquad ( Formula 7 )$$

$$If {f ( object )}_{object - detection} = false , set {Flag}_{trash - c 3} = true \qquad ( Formula 8 )$$

When any of the formulas 6 to 8 does not meet the standard of the left object, checking whether the staying time duration_{stay_up} is greater than thr_{stay-up-duration}/2. If so, the displacement amount is reset to indicate that the object is still moving. The purpose of this design is to solve a situation where the left object is continuously moving, such as discarding the left object from a car, or a situation where the left object is thrown a distance far away. After completing the left object detection, the tracking_list is sent to the integrated system to determine whether there is an event.

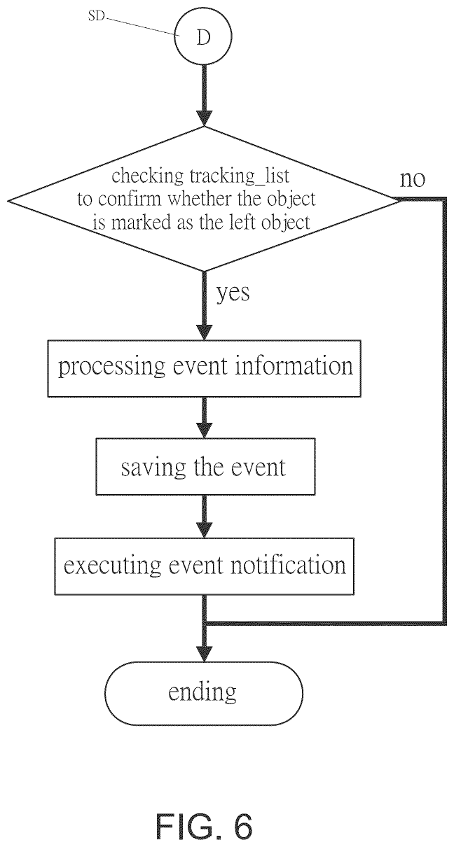

The integrated system is shown in FIG. 6, wherein after the left object detection is completed, the event center 133 enters a judgment. The event center 133 processes the object in the tracking_list according to whether it is marked as left object. When it is determined to be the left object, an event information, an event saving and a notification are executed.

Accordingly, the method for detecting the left object and the integrated system by using the same of the present invention has advantages as follows:
1) proposing an improved foreground detection algorithm architecture to capture dynamic behaviors in video and match them with the object detection, and to enhance the foreground by reducing resolution and noise, and expanding the foreground to solve the problem of object detection errors in situations where the environment changes.
2) using the algorithms to match and track the left object, solving the misjudgment of the left object because of light and shadow reflections, and tracing back to find the person who loses the object.
3) training model by using artificial intelligence to predict and extract tracking image features, and the cosine similarity comparison method is configured to detect the left object, thus solving difficulty in identifying the left object.

While the first embodiments of the invention have been set forth for the purpose of disclosure, modifications of the disclosed embodiments of the invention as well as other embodiments thereof may occur to those skilled in the art. The scope of the claims should not be limited by the first embodiments set forth in the examples, but should be given the broadest interpretation consistent with the description as a whole.

What is claimed is:

1. A method for detecting a left object comprising steps of: a step A of executing a pre-processing procedures, a step B of matching and tracking, and a step C of detecting the left object;
in the step A includes:
1) taking a pixel and initializing a background model which has values taken in a past at a same location or a neighborhood;
2) taking a new pixel and comparing the new pixel with the values of the background model, wherein when values of the new pixel are close to values of the background model, the new pixel is determined to the background, otherwise the new pixel is considered to the foreground;
3) when the new pixel is determined to the background, the values of the background model is updated as the values of the new pixel with a predetermined probability, and the values of the new pixel are propagated to the background model of the neighboring pixels with a predetermined probability; and
4) repeating the steps of 2) and 3) until all pixels are processed completely; and
5) detecting the left object in a scene;
wherein in the step B, the left object is detected in an original RGB image, and the object that often appears in a monitoring environment is selected;
wherein in the step C, the object is detected to determine whether being seen commonly in the scene based on an object overlap ratio, an object displacement, and an object staying time.

2. The method as claimed in claim 1, wherein after the foreground detection is completed, a mask is generated, A content marked by the mask is the foreground and background after subtracting the two images, wherein the foreground is marked in white, and the background is marked in black, wherein BGS_Frame represents a result of a frame after executing a background subtraction (BGS); after the foreground detection, there are quite a lot of tiny white dots in BGS Frame, which need to be filtered out through processing, wherein reducing the resolution in the pre-processing procedures is configured to remove the tiny white dots and to reduce a subsequent calculation amount.

3. The method as claimed in claim 1, wherein a number of white pixels in a connected area of BGS Frame is calculated, and a threshold value thr_{denoise} for a noise reducting judgment is set, when the number of the white pixels in the connected area WPixel_{BGS-CC} is less than thr_{denoise}, it is regarded as noise, and all white areas regarded as the noise (the foreground with a value 1) are changed to a black (the background with a value 0), thus filtering the noises.

4. The method as claimed in claim 1, wherein in the step B, the object is continuously updated and tracked, wherein the list of object being tracked is represented by a tracking_list, and the tracking_list is a list used to store the object currently being tracked, wherein in every frame, the tracking_list is updated, and when an object is considered new or does not match with a currently tracked object, the object is added to the tracking_list, wherein when an object has not been matched for multiple consecutive frames, the object is removed from the tracking_list.

5. The method as claimed in claim 4, wherein after the step B, the BBox and the total_mask are output to analyze the object in a connected domain and generate a list of interest_box list of object of interest, wherein the interest_box is a list used to store all object in a current frame, wherein the interest_box is obtained by analyzing the connected domain, and each object is a rectangular box, indicating a position of the object in an image.

6. The method as claimed in claim 5, wherein multiple variables used to match include an intersection area (IoU), a size difference (size-diff) and a similarity (similarity), wherein the intersection area (IoU) is denoted as a size of an intersection area of two matched objects, wherein a variable of IoU is between 0 and 1, 0 represents no intersection between the two object, and 1 represents an overlap between the two matched objects, wherein the closer the IoU value is to 1, the more the two matched objects match, the size-diff is denoted as a difference in an area of the BBox of the two matched objects being matched, and the area is the number of pixels, wherein a calculation method of size-diff is to subtract a number of pixels of the two matched objects and divide an absolute value by a larger value between the two matched objects, and a value of the size-diff obtained after calculation is between 0 and 1, wherein the closer the value is to 0, the more matched the two matched objects are.

7. The method as claimed in claim 6, wherein after matching, when the matching is successful, it will continue to determine whether it is the left object, if the matching fails, it means this is a new object, and it will be added to the tracking_list for continuous tracking in a next frame; after excluding the matched object, checking whether the object is blocked; when an object frame overlaps with a range of other object frames in the current frame, it means that the object is blocked and it is necessary to confirm whether it is the left object; when it is not covered, checking whether the similarity is greater than 0.9; when it is greater than 0.9, it means that the object is currently being tracked and has a staying time (duration_{stay_up})+1; when the similarity is less than 0.9, it means that the object in the image has changed and the similarity is not high; when an object fails to match with the foreground for several consecutive frames, it means that the object is the background and is removed; after matching, the object in the interest_box and tracking_list has to be updated; the object in the interest_box replaces the corresponding object in tracking_list based on a matching relationship, finally the object box is marked and output to a left object detection program.

8. The method as claimed in claim 7, wherein data input to the left object detection program is the list of object in the interest_box that has been matched; each matched object is first compared with the interest_box and the tracking_list to check whether the intersection area (IoU), the size difference (size-diff), and the similarity (similarity) are consistent with the same object, thus overcoming misdetection of highly homogeneous object; after detecting, when any of the three conditions inclusive of the intersection area (IoU), the size difference (size-diff), and the similarity does not meet the set threshold conditions, it means that the object is not a target object and is separated from the original image into a new object and added to the tracking_list to continuous track when a next image is input; when all three thresholds are passed, it means that the object is currently being continuously tracked, after updating the box information of the object frame, further detecting is required to determine whether it is the left object.

9. The method as claimed in claim 8, wherein in the step C, detection conditions includes 1) when the object is not continue to move, a movement threshold (thr_{moved}) is defined, wherein when the object is less than the movement threshold, the object is the left object;
2) when the object continues to stay in a same place, defining a threshold for a duration of an object's staying (thr_{stay-up-duration}), wherein when the object stays in a scene for a period of time and a staying time is greater than the threshold, the object is considered as the left object;
3) when the object is not recognized in the scene, defining an object detection function f(x)_{object-detection} with an input being the object to be tracked, the output being true or false, and indicating whether a common object is detected;
wherein when any of the 1) to 3) does not meet a standard of the left object, checking whether the staying time duration_{stay_up} is greater than thr_{stay-up-duration}/2; if so, a displacement amount is reset to indicate that the object is still moving, thus solving a situation where the left object is continuously moving, which is discarding the left object from a car, or a situation where the left object is thrown a distance far away.

10. An integrated system by using the method of claim 1 comprising: a surveillance camera, a communication station, a network switch, a cloud computing server, and a mail server;
wherein the cloud computing server includes at least one artificial intelligence engine (AI Engine), a streaming server, a database server, and an event center; the surveillance camera is configured to capture a real-time surveillance video at a fixed point and to transmit a video data of the real-time surveillance video via a communication network;
wherein the real-time surveillance video is transmitted to the cloud computing server via the communication station and the network switch, and a streaming image is received by the streaming server;
wherein the AI engine is configured to execute a method for detecting the left object and is provided in the integrated system;
wherein when the left object is detected, a detected data of the left object is immediately transmitted to the event center to start an event processing, save the detected data of the left object in the database server, and notify monitoring personnel from the email server notifies via a computer or a mobile phone of the monitoring personnel.
